(19) United States
(12) Patent Application Publication
(10) Pub. No.: US 2022/0373477 A1
(43) Pub. Date: Nov. 24, 2022

(54) APPARATUS FOR DETECTING FINE DUST AND MICROORGANISMS

(71) Applicant: MEDIAEVER. CO., LTD., Suwon-si, Gyeonggido (KR)

(72) Inventor: Byung In MA, Suwon-si, Gyeonggi-do (KR)

(73) Assignee: MEDIAEVER. CO., LTD., Suwon-si, Gyeonggido (KR)

(21) Appl. No.: 17/769,767

(22) PCT Filed: Sep. 19, 2019
(86) PCT No.: PCT/KR2019/012125

§ 371 Date: Apr. 18, 2022

(51) Int. Cl. G01N 21/94; G01N 21/64; G01N 21/47

(52) U.S. Cl. CPC G01N 21/94; G01N 21/64; G01N 21/47

(57) ABSTRACT

An apparatus for detecting fine dust and microorganisms includes: a sample chamber body including a sample chamber, a light-incidence port through which incident light is incident, and a first light exit port and a second light exit port for emitting the incident light irradiated to the measurement sample; a light-transmitting unit; a first light-receiving unit which separately transmits, via a first path and a second path, exiting light emitted from the first light exit port, detects scattering light from the exiting light transmitted via the first path, and detects fluorescence light of the exiting light transmitted via the second path; a diffused reflection reduction unit provided between the first light exit port and the first light-receiving unit; and a second light-receiving unit which condenses in a Mie-scattering manner and transmits exiting light emitted from the second light exit port and detects fluorescence light of the exiting light.

### TECHNICAL FIELD

The present invention relates to an apparatus for detecting fine dust and microorganisms, and more particularly, to an apparatus for detecting fine dust and microorganisms enabling double detecting of exiting light, particularly fluorescence light through a first light-receiving unit using a circular mirror and a second light-receiving unit using Mie-scattering.

### BACKGROUND ART

Recently, as the industry has developed, the generation of pollutants is also greatly increased, and these pollutants include various harmful substances such as fine dust and microorganisms. Among these pollutants, it has been found that substances that are commonly encountered in the vicinity, such as fine dust or microorganisms, may have a fatal effect on the human body, and even at the national level, concentrations and the like of yellow dust and fine dust are forecasted through weather forecasts, etc.

In order to prevent and minimize actual damage to fine dust and microorganisms, in addition to national or regional forecasting, continuous monitoring and countermeasures thereof are required in public places or facilities where many people gather.

In response to the demand, research and development for an apparatus capable of very precisely detecting fine dust and microorganisms have been continuously performed.

Conventional microorganism detection technology has gone through a process of collecting a sample for measurement in the atmosphere, culturing the collected sample in a medium, and detecting microorganisms through the number and homogeneity of the cultured microorganism groups.

However, the method has a disadvantage in that it takes several hours to several days or more to culture the collected microorganisms, and recently, research on an optical detector capable of monitoring the atmospheric state in real time has been actively conducted.

FIG. 1 is a diagram schematically illustrating an optical detector for detecting fine dust and microorganisms in the related art.

In the optical detector illustrated in FIG. 1, while aerosols as a measurement sample are introduced into a sample chamber 31 having an inner wall surface consisting of an elliptical mirror 32, a light source unit 33 irradiates light to the measurement sample in the sample chamber 31 and condenses scattering light and fluorescence light generated by colliding with the measurement sample, respectively, to detect the fine dust and microorganisms.

However, in the conventional optical detector, since the light source unit 33 is an incoherent optical source, there is a problem that detection performance is deteriorated due to optical noise, and detection efficiency is reduced due to diffused reflection by a lens.

In addition, since there is a limit to a detectable wavelength band of fluorescence light of incident light irradiated to the measurement sample, the detection resolution of equipment is lowered and accordingly, there is a problem in that it is difficult to obtain an accurate detection value from fluorescence light by setting equipment by focusing on a specific wavelength band.

### DISCLOSURE

### Technical Problem

The present invention has been proposed to solve the above problems, and it is possible to provide an apparatus for detecting fine dust and microorganisms capable of improving the detection efficiency by enabling detection in a double detecting manner through a second light-receiving unit of Mie-scattering together with a first light-receiving unit of a sample chamber to improve the detection performance due to optical noise as compared with the related art and minimizing the diffused reflection by the lens, improving the detection resolution of the equipment by increasing a detectable wavelength band of fluorescence light of incident light irradiated to the measurement sample, and securing accurate detection data from the fluorescence light.

### Technical Solution

According to an aspect of the present invention, an apparatus for detecting fine dust and microorganisms may comprise: a sample chamber body comprising a sample chamber into which a measurement sample is introduced and of which the inside is implemented as a reflector, a light-incidence port through which incident light is incident, and a first light exit port and a second light exit port for emitting the incident light irradiated to the measurement sample; a light-transmitting unit which irradiates the incident light from the light-incidence port and blocks ambient light from entering the incident light; a first light-receiving unit which separately transmits, via a first path and a second path, exiting light emitted from the first light exit port, detects scattering light from the exiting light transmitted via the first path, and detects fluorescence light of the exiting light transmitted via the second path so as to detect fluorescence light of a predetermined wavelength band from wavelength bands irradiated from the light-transmitting unit; a diffused reflection reduction unit provided between the first light exit port and the first light-receiving unit to reduce diffused reflection light emitted from the first light exit port; and a second light-receiving unit which condenses in a Mie-scattering manner and transmits exiting light emitted from the second light exit port and detects fluorescence light of the exiting light emitted from the second light exit port so as to detect fluorescence light of the remaining wavelength bands not received by the first light-receiving unit from the wavelength bands irradiated from the light-transmitting unit.

The reflector may include an upper body and a lower body, the upper body may be a circular mirror and the lower body may be an elliptical mirror, and the circular mirror may be formed with an aperture corresponding to the first light exit port.

The center of the circular mirror may be a first focus of the elliptical mirror, and the diffused reflection reduction unit may be coupled to the position of a second focus of the elliptical mirror.

The diffused reflection reduction unit may be provided in a disk shape.

A lower inner diameter and an upper inner diameter of a through hole formed in the aperture of the disk may be formed to have different diameters from each other.

The first light-receiving unit may include a first condensing lens unit for condensing exiting light emitted from the first light exit port; a first spectral element which reflects exiting light with the same wavelength as the incident light of the exiting light condensed by the first condensing lens unit via the first path and passes through the exiting light with a different wavelength via the second path; and a first fluorescence detecting unit for detecting the fluorescence light from the exiting light via the second path.

The lower wall of the disk may be provided with a first band-pass filter unit having an optical density of 9 or more.

The second light-receiving unit may include a second condensing lens unit for condensing exiting light emitted from the second light exit port; a second spectral element which reflects exiting light with the same wavelength as the incident light of the exiting light condensed by the second condensing lens unit via the third path and passes through the exiting light with a different wavelength from the incident light of the exiting light condensed by the first condensing lens unit via the fourth path; a third spectral element which reflects fluorescence light having a different wavelength from the incident light of the exiting light passing through the second spectral element via the fifth path and transmits light having a wavelength other than the fluorescence light of the exiting light reflected by the second spectral element via the sixth path; and a second fluorescence detecting unit for detecting the fluorescence light from the exiting light via the fifth path.

The second fluorescence detecting unit may include a Mie-scattering fluorescence filter unit which is implemented as a second band-pass filter unit having an optical density of greater than 6 and smaller than 9 to block the light other than the fluorescence wavelength and transmit only the exiting light having the fluorescence wavelength; a Mie-scattering condensing lens unit for condensing the exiting light passing through the Mie-scattering fluorescence filter unit; and a Mie-scattering light control unit for removing optical noise included in the exiting light condensed by the Mie-scattering condensing lens unit.

The light-transmitting unit may irradiate incident light of a wavelength band of 320 nm to 605 nm, a predetermined wavelength band of the fluorescence light of the first light-receiving unit may be 495 nm to 605 nm, and the remaining wavelength bands of the fluorescence light of the second light-receiving unit may be 320 nm to 505 nm.

### Advantageous Effects

According to the apparatus for detecting fine dust and microorganisms of the present invention, it is possible to improve the detection efficiency by enabling detection in a double detection manner through a second light-receiving unit of Mie-scattering together with a first light-receiving unit of a sample chamber to improve the detection performance due to optical noise as compared with the related art and minimizing the diffused reflection by the lens. Further, it is possible to improve the detection resolution of the equipment by increasing a detectable wavelength band of fluorescence light of incident light irradiated to the measurement sample, and secure accurate detection data from the fluorescence light.

### DESCRIPTION OF DRAWINGS

FIG. 1 is a diagram schematically illustrating an optical detector for detecting fine dust and microorganisms in the related art.

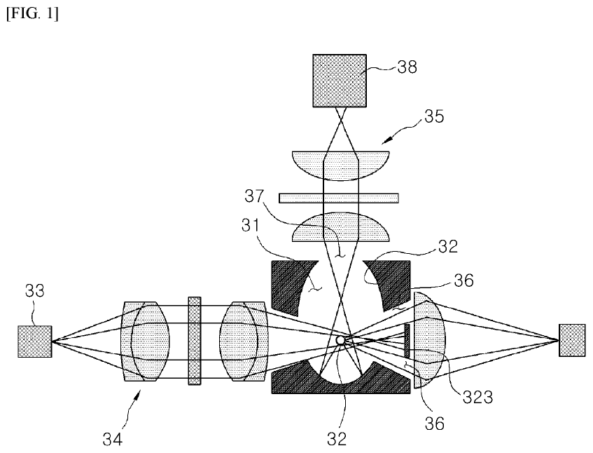

FIG. 2 is a diagram illustrating an apparatus for detecting fine dust and microorganisms according to an embodiment of the present invention.

FIG. 3 is a diagram illustrating a relationship between a circular mirror and an elliptical mirror according to an embodiment of the present invention.

FIG. 4 is a diagram illustrating a diffused reflection reduction unit and a first band-pass filter unit having a disk-shaped structure according to an embodiment of the present invention.

FIG. 5 is a diagram illustrating a DC waveform received by an optical sensor of a first light-receiving unit according to an embodiment of the present invention.

FIG. 6 is a diagram illustrating wavelength bands of fluorescence light passing through first and second light-receiving units via first and second band-pass filter units according to the present invention.

FIG. 7 is a schematic detailed diagram of a second light-receiving unit according to an embodiment of the present invention.

### BEST MODE FOR THE INVENTION

Hereinafter, an embodiment of an apparatus for detecting fine dust and microorganisms according to the present invention will be described in detail with reference to the accompanying drawings. Like reference numerals illustrated in the respective drawings designate like members.

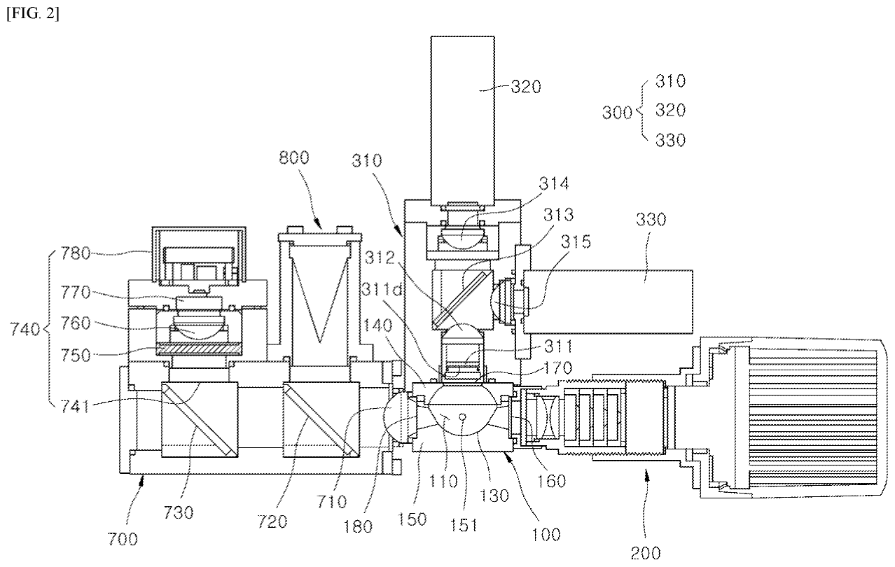

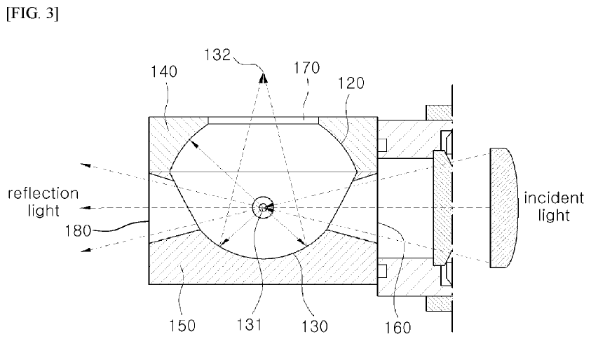

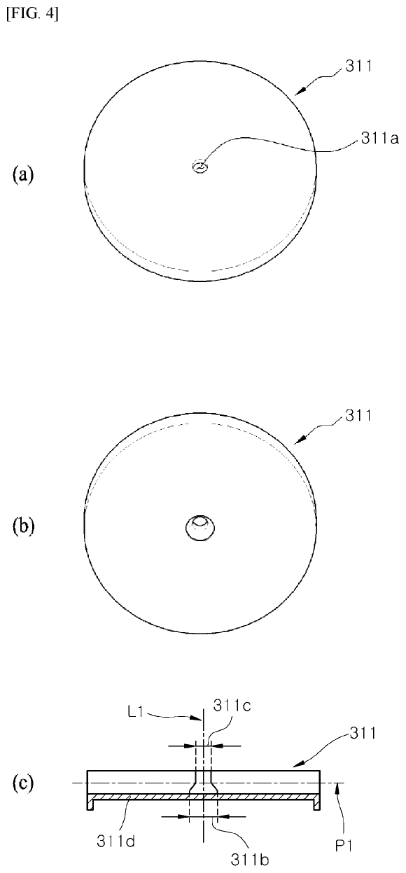

FIG. 2 is a diagram illustrating an apparatus for detecting fine dust and microorganisms according to an embodiment of the present invention, FIG. 3 is a diagram illustrating a relationship between a circular mirror and an elliptical mirror according to an embodiment of the present invention, and FIG. 4 is a diagram illustrating a diffused reflection reduction unit and a first band-pass filter unit having a disk-shaped structure according to an embodiment of the present invention.

Referring to FIGS. 2 and 3, an apparatus for detecting fine dust and microorganisms (hereinafter, referred to as a ‘detection apparatus’ 10) according to an embodiment of the present invention may include: a sample chamber body 100 comprising a sample chamber 110 into which a measurement sample is introduced and of which the inside is implemented as a reflector, a light-incidence port 160 through which incident light is incident, and a first light exit port 170 and a second light exit port 180 for emitting the incident light irradiated to the measurement sample; a light-transmitting unit 200 which irradiates the incident light from the light-incidence port 160 and blocks ambient light from entering the incident light; a first light-receiving unit 300 which separately transmits, via a first path and a second path, exiting light emitted from the first light exit port 170, detects scattering light from the exiting light transmitted via the first path, and detects fluorescence light of the exiting light transmitted via the second path so as to detect fluorescence light of a predetermined wavelength band from among wavelength bands irradiated from the light-transmitting unit 200; a diffused reflection reduction unit 311 provided between the first light exit port 170 and the first light-receiving unit 300 to reduce diffused reflection light emitted from the first light exit port 170; and a second light-receiving unit 700 which condenses in a Mie-scattering manner and transmits exiting light emitted from the second light exit port 180 and detects fluorescence light of the exiting light emitted from the second light exit port 180 so as to detect fluorescence light of the remaining wavelength bands not received by the first light-receiving unit 300 from the wavelength bands irradiated from the light-transmitting unit 200.

The sample chamber 110 provided by the sample chamber body 100 includes an upper body 140 and a lower body 150, and the upper body 140 is provided with a circular mirror 120, and the lower body 150 is provided with an elliptical mirror 130, and a part of the circular mirror 120 and a part of the elliptical mirror 130 as the lower portion thereof may be configured in combination. The measurement sample, for example, a sample aerosol is introduced into the sample chamber 110 through a sample inlet 151.

In addition, an inlet nozzle of a nozzle unit (not illustrated) is connected to the sample inlet 151 of the sample chamber body 100, and the sample aerosol to be measured is introduced to the sample chamber 110 through the inlet nozzle, and the introduction position of the sample aerosol is a first focus portion 131 where the incident light of the light-transmitting unit 200 is focused. Although not illustrated in the drawing, the sample chamber body 100 on the opposite side of the sample inlet 151 is provided with a sample outlet to discharge the introduced sample aerosol to the outside of the sample chamber 110.

The center of the circular mirror 120 in the sample chamber 110 is a first focus 131 of the elliptical mirror 130, and the circular mirror 120 has an aperture formed to correspond to the first light exit port 170.

According to an embodiment, the radius of the circular mirror 120 is preferably selected from a value between 13 mm and 14 mm, and the size of the aperture formed in the circular mirror 120 is preferably selected from a value between 14.5 mm and 15.5 mm.

The elliptical mirror 130 in the sample chamber 110 may have two focuses 131 and 132, the light incident from the light-transmitting unit 200 is substantially converged to the first focus 131 of the elliptical mirror 130 and irradiated to the measurement sample introduced into the aerosol, and the light colliding with particles in the measurement sample is scattered and refracted and then emitted to the first light exit port 170 of the sample chamber 110 toward the second focus 132 of the elliptical mirror 130 through the aperture of the circular mirror 120 coupled with the elliptical mirror 130 by the elliptical mirror 130.

According to the embodiment, the length of the minor axis of the elliptical mirror 130 is preferably selected from a value between 25.5 mm and 26.5 mm, and the length of the major axis of the elliptical mirror 130 is preferably selected from a value between 32 mm and 33 mm. In addition, the focal distance between the first focus 131 and the focus 132 of the elliptical mirror 130 is preferably selected from a value between 19 mm and 20 mm.

In more detail, the light incident to the light-incidence port 160 is substantially converged to the first focus 131 of the elliptical mirror 130 and irradiated to the measurement sample introduced into the aerosol and the light colliding with the particles in the measurement sample is scattered and refracted.

The light refracted by the elliptical mirror 130 of the scattered and refracted light is emitted to the outside through the first light exit port 170 toward the second focus 132 by the elliptical mirror 130. In addition, the light refracted by the circular mirror 120 of the scattered and refracted light is directed to the first focus 131 of the elliptical mirror 130 by the circular mirror 120, and the light passing through the first focus 131 of the elliptical mirror 130 is emitted to the outside through the first light exit port 170 toward the second focus 132 by the elliptical mirror 130.

Accordingly, the light incident only through reflection up to two times may be emitted to the outside through the first light exit port 170 toward the second focus 132 by the elliptical mirror 130 so that the signal attenuation is proportional to the number of times to be reflected by the reflector, and the apparatus for detecting fine dust and microorganisms according to the embodiment of the present invention may minimize the signal attenuation by the reflection.

In addition, as compared with a case where the sample chamber 110 consists of only the elliptical mirror 130 in the related art, since a part of the circular mirror 120 as an upper portion and a part of the elliptical mirror 130 as a lower portion are combined, in the case of the embodiment consisting of the sample chamber 110, the size of the sample chamber 110 is relatively smaller so that the possibility of miniaturization is much high.

The light-transmitting unit 200 for irradiating the light to the sample chamber 110 irradiates UV light using a light emitting diode (LED) to the measurement sample in the sample chamber 110 through the light-incidence port 160 and the irradiated UV light collides with the aerosol particles introduced into the sample chamber 110 to generate scattering light and fluorescence light.

At this time, an LED, which is a light emitting element of the light-transmitting unit 200, may be disposed to emit light in a direction incident to the sample chamber 110, that is, toward the light-incidence port 160, and may emit the light in a UV region of 320 nm to 605 nm, suitable for simultaneous detection of fine dust and microorganisms. Preferably, the LED may emit light in the UV region of 340 nm to 580 nm to minimize fluorescence light of inanimate objects.

The light-transmitting unit 200 condenses the light irradiated into the sample chamber 110 to a predetermined point in the sample chamber 110. The predetermined point means the first focus 131 of the elliptical mirror 130, and since the measurement sample aerosol is introduced into the first focus portion 131, the light focus of the light-transmitting unit 200 coincides with the introducing position of the measurement sample, thereby improving the detection capacity of fine dust and microorganisms of the detection apparatus 10.

Referring back to FIG. 2, the first light-receiving unit 300 may include an optical system 310 including a first condensing lens unit 312 for condensing exiting light emitted from the first light exit port 170; a first spectral element 313 which reflects exiting light with the same wavelength as the incident light of the exiting light condensed by the first condensing lens unit 312 via the first path and passes through the exiting light with a different wavelength via the second path; and a first fluorescence detecting unit 320 for detecting the fluorescence light from the exiting light via the second path.

In addition, the optical system 310 is disposed outside the first light exit port 170 of the sample chamber body 100, and may further include a diffused reflection reduction unit 311, a fluorescence condensing lens unit 314, and a scattering light condensing lens unit 315.

FIG. 4 is a diagram illustrating a diffused reflection reduction unit and a first band-pass filter unit having a disk-shaped structure according to an embodiment of the present invention.

Referring to FIGS. 2 to 4, in the diffused reflection reduction unit 311 has an aperture 311a formed in the center to transmit the light emitted from the first light exit port 170.

The diffused reflection reduction unit 311 may be provided in a disk-shaped structure in which the aperture is formed in the center illustrated in FIG. 4.

The diffused reflection reduction unit 311 may be coupled to the position of the second focus of the elliptical mirror. That is, the diffused reflection reduction unit 311 is coupled to a predetermined position from the first light exit port 170, wherein the predetermined position is a position where a virtual point generated by crossing a virtual line L 1 formed vertically to the center of an aperture 311a formed in the center of the diffused reflection reduction unit 311 with a virtual plane P1 formed in parallel with the diffused reflection reduction unit 311 to pass through a half of the thickness of the diffused reflection reduction unit 311 coincides with the second focus 132 of the elliptical mirror 130.

The size of an upper inner diameter 311c of the aperture 311a formed in the center of the diffused reflection reduction unit 311 is preferably 50% to 200 of the size of an optical focus formed by the elliptical mirror 130.

The aperture 311a formed in the center of the diffused reflection reduction unit 311 may have different diameters of a lower inner diameter 311b and an upper inner diameter 311c, and the diameter of the lower inner diameter 311b may be greater than the diameter of the upper inner diameter 311c in order to transmit only the light accurately scattered and refracted from the first focus 131 of the elliptical mirror 130 of the light emitted from the first light exit port 170.

Accordingly, it is possible to effectively remove optical noise included in the light emitted from the first light exit port 170.

When the diffused reflection reduction unit 311 is described in more detail, the light emitted from the first light exit port 170 is the light staring from the first focus 131 of the elliptical mirror 130 to pass through the second focus 132 of the elliptical mirror 130. A virtual point generated by crossing a virtual line formed vertically to the center of the aperture 311a formed in the center of the diffused reflection reduction unit 311 and a virtual plane formed in parallel with the diffused reflection reduction unit 311 so as to pass through a half of the thickness of the diffused reflection reduction unit 311 coincides with the second focus 132 of the elliptical mirror 130, so that the light emitted from the first light exit port 170 passes through the aperture 311a formed in the center of the diffused reflection reduction unit 311.

Accordingly, only the light accurately scattered and refracted from the first focus 131 of the elliptical mirror 130 of the light emitted from the first light exit port 170 passes through the aperture 311a formed in the center of the diffused reflection reduction unit 311, and the optical noise generated from the sample chamber 110 and output to the first light exit port 170 may be blocked by the diffused reflection reduction unit 311.

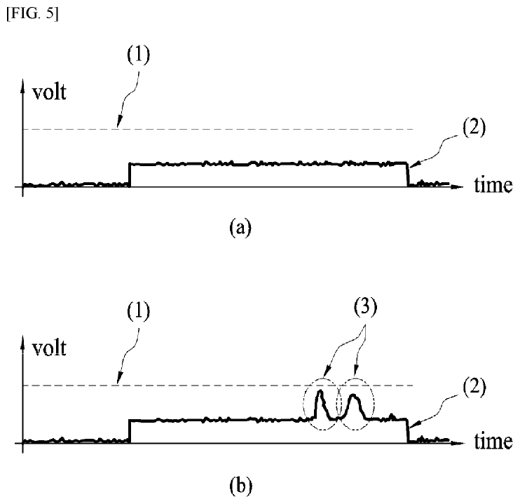

FIG. 5 is a diagram illustrating a DC waveform received by an optical sensor of a first light-receiving unit according to an embodiment of the present invention.

When the LED of the conventional light-transmitting unit 200 is turned on, since the optical noise is generated by characteristics of the LED, which is an incoherent optical source, a barrel structure of the light-transmitting unit 200, a lens design of the light-transmitting unit 200 or diffused reflection by the lens, etc., an output voltage DC waveform of the first fluorescence detecting unit 320 in which the diffused reflection reduction unit 311 is not mounted approaches a saturation voltage of the detection sensor of the first fluorescence detecting unit 320 so that the detection efficiency is deteriorated.

Referring to FIG. 5, (1) illustrated in FIG. 5A illustrates a saturation voltage of the detection sensor of the first fluorescence detecting unit 320 and (2) illustrates an output voltage generated in an LED on period. It can be seen that although the LED of the light-transmitting unit 200 is turned on, the optical noise generated by the characteristics of the LED, which is an incoherent optical source, the barrel structure of the light-transmitting unit 200, the lens design of the light-transmitting unit 200 or the diffused reflection by the lens, etc. is blocked by the diffused reflection reduction unit 311 according to the present invention and the output voltage DC waveform of the first fluorescence detecting unit 320 has a significant difference from a saturation voltage of the detection sensor of the first fluorescence detecting unit 320.

In addition, (1) illustrated in FIG. 5B illustrates a saturation voltage of the detection sensor of the first fluorescence detecting unit 320, (2) illustrates an example of the output voltage DC waveform of the first fluorescence detecting unit 320 when microorganisms are introduced into the sample inlet 151 in the LED on period, and (3) illustrates an example of the detection signal due to fluorescence reaction of microorganisms.

Referring to (2) and (3) illustrated in FIG. 5B, it can be seen that the output voltage DC waveform of the of the first fluorescence detecting unit 320 is significantly different from the saturation voltage of the detection sensor of the first fluorescence detecting unit 320, and two peaks are formed due to the fluorescence reaction of microorganisms. That is, it can be seen that when the diffused reflection reduction unit 311 according to the present invention blocks the optical noise, although the LED of the light-transmitting unit 200 is turned on, the output voltage DC waveform of the of the first fluorescence detecting unit 320 outputs a low DC voltage having the significant difference from the saturation voltage of the detection sensor of the first fluorescence detecting unit 320 and a microorganism detection signal which is a peak generated by the fluorescence reaction of microorganisms is clearly detected.

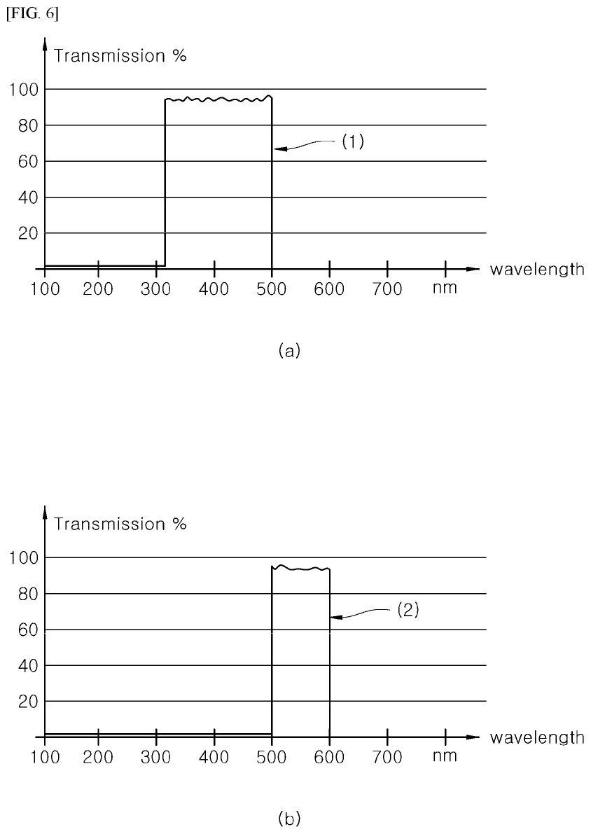

FIG. 6 is a diagram illustrating wavelength bands of fluorescence light passing through first and second light-receiving units 700 via first and second band-pass filter units according to the present invention.

The lower wall of the diffused reflection reduction unit 311 illustrated in FIG. 2, precisely the lower wall of the disk may be provided with a first band-pass filter unit 311d having an optical density of 9 or more and 12 or less. The first band-pass filter unit 311d interacts with a second band-pass filter unit 750 of the second light-receiving unit 700 to serve to increase a detectable wavelength band of fluorescence light of the incident light irradiated to the measurement sample and increase the detection resolution of the equipment, which will be described below.

Meanwhile, referring back to FIG. 2, the first condensing lens unit 312 serves to make light (e.g., scattering light and fluorescence light) emitted from the first light exit port 170 of the sample chamber 110 into a parallel beam.

The first spectral element 313 changes a path of the scattering light of which the wavelength is not changed in the light passing through the first condensing lens unit 312 to the first path, and the fluorescence light of which the wavelength is changed passes through the first path.

A fluorescence condensing lens unit 314 is disposed on the second path of the fluorescence light passing through the first spectral element 313 as it is, and on the first path of the scattering light of which the path is changed in the first spectral element 313, a scattering light condensing lens unit 315 may be disposed.

The fluorescence condensing lens unit 314 disposed between the first spectral element 313 and a first fluorescence detecting unit 320 serve to converge the parallel fluorescence light passing through the first spectral element 313 to the first fluorescence detecting unit 320. The scattering light condensing lens unit 315 disposed between the first spectral element 313 and a scattering light-receiving unit 330 serves to converge the parallel scattering light with a changed path in the first spectral element 313 to the scattering light-receiving unit 330.

The first fluorescence detecting unit 320 and the scattering light receiving unit 330 detect the presence or absence of fine dust and microorganisms and the amount thereof from the light transmitted through the fluorescence condensing lens unit 314 and the scattering light condensing lens unit 315, respectively. That is, the first fluorescence detecting unit 320 and the scattering light receiving unit 330 receive the scattering light and the fluorescence light emitted to the outside of the sample chamber 110, respectively, and generate a detection signal for the received light to be transmitted to a signal processing unit (not illustrated).

Since auto-fluorescence light by microorganisms is a very fine signal compared to the scattering light, the first fluorescence detecting unit 320 may be implemented as a photo multiplier tube (PMT), and the detected fluorescence light may include information about the presence or absence of microorganisms and its amount. In the embodiment, a predetermined wavelength band of the fluorescence light of the first light-receiving unit 300, precisely, the first fluorescence detecting unit 320 may be set to 495 nm to 605 nm.

Such a wavelength band is because the first band-pass filter unit 311d is provided in the diffused reflection reduction unit 311. More specifically, in the first band-pass filter unit 311d, in order to block light other than a fluorescence wavelength, the optical density of the first band-pass filter unit 311d is greater than 9 and smaller than 12.

Here, the optical density of the band-pass filter refers to the ability of transmitting or blocking light having a specific wavelength. As illustrated in FIG. 6A, when the optical density of the first band-pass filter unit 311d is 9 or more and 12 or less, most (95% or more (1)) of fluorescence light (495 to 605 nm, average wavelength of about 580 nm) irradiated from the first light exit port 170 enters the first fluorescence detecting unit 320, but a relatively short fluorescence wavelength of less than 500 nm cannot enter the optical system 310 by the first band-pass filter unit 311d.

The scattering light receiving unit 330 may be implemented as a photodiode, and the scattering light detected by the scattering light receiving unit 330 may include information on the presence or absence of fine dust and the amount thereof.

Meanwhile, the light-transmitting unit 200 in the embodiment may be implemented with only a single LED as described above to enable Mie-scattering detection. The Mie-scattering means that the scattering direction of the incident light is determined by a relationship between the wavelength of the incident light and the size of particles in the air. When the size of the particles is tens of times larger than the wavelength of incident light and hundreds of times smaller therethan, according to Mie-scattering, most of the incident light scattered by colliding with the particles is directed in the forward direction.

Accordingly, when the size of the particles to which Mie-scattering may be applied is tens of times larger than the wavelength of incident light and hundreds of times smaller therethan, most of the incident light scattered by colliding with the particles is directed in an incident direction of the incident light, and when a light-receiving means is installed in the incident direction of the incident light, it is possible to detect the fluorescence light which is the scattered incident light.

Accordingly, the second light-receiving unit 700 may be connected to a second light exit port 180.

Referring back to FIG. 2, the second light-receiving unit 700 may include a second condensing lens unit 710 for condensing exiting light emitted from the second light exit port 180; a second spectral element 720 which reflects exiting light having the same wavelength as the incident light of the exiting light condensed by the second condensing lens unit 710 via the third path and transmits exiting light having a different wavelength from the incident light of the exiting light condensed by the second condensing lens unit 710 via the fourth path; a third spectral element 730 which reflects fluorescence light having a different wavelength from the incident light of the exiting light passing through the second spectral element 720 via the fifth path and transmits light having a wavelength other than the fluorescence light of the exiting light reflected by the second spectral element 720 via the sixth path; and a second fluorescence detecting unit 740 for detecting the fluorescence light from the exiting light via the fifth path.

The second condensing lens unit 710 serves to make the light (e.g., fluorescence light) emitted from the second light exit port 180 into a parallel beam. The second condensing lens unit 710 may be implemented as a collimator lens, and in this case, a collimator lens having a relatively large numerical aperture (NA) value is used.

For example, when the numerical aperture (NA) value of the collimator lens is 0.6, an incident angle is plus minus 36.8°. When the incident angle is plus or minus 36.8°, 70% or more of the fluorescence light scattered from the second light exit port 180 may be condensed.

The second spectral element 720 reflects the scattering light of which the wavelength is not changed in the light passing through the second condensing lens unit 710 via the third path and transmits the fluorescence light of which the wavelength is changed via the fourth path.

The third spectral element 730 reflects the fluorescence light having a different wavelength from the incident light of the exiting light transmitted by the second spectral element 720 via the fourth path and transmits the fluorescence light having the same wavelength as the incident light of the exiting light via the sixth path.

Since the third spectral element 730 reflects only light of a wavelength corresponding to the fluorescence light, the light having a wavelength other than fluorescence light included in the exiting light transmitted by the second spectral element 720 via the fourth path passes through the sixth path passing through the third spectral element 730 and is stopped.

Since the third spectral element 730 reflects only fluorescence light having a wavelength band different from the incident light by the second fluorescence detecting unit 740 to be described below, it is possible to minimize an effect by diffused reflection generated by the characteristics of the LED, which is an incoherent optical source.

Referring to FIGS. 2 and 6, the second fluorescence detecting unit 740 may include a Mie-scattering fluorescence filter unit 750 which is implemented as a second band-pass filter unit 750 having an optical density of greater than 6 and smaller than 9 to block the light other than the fluorescence wavelength and transmit only the exiting light having the fluorescence wavelength; a Mie-scattering condensing lens unit 760 for condensing the exiting light passing through the Mie-scattering fluorescence filter unit 750; and a Mie-scattering light control unit 770 and a Mie-scattering fluorescence sensor unit 780 for removing optical noise included in the exiting light condensed by the Mie-scattering condensing lens unit 760.

A Mie-scattering fluorescence inlet 741 is an aperture formed to transmit the scattering light that has passed through the third spectral element 730 via the fifth path.

The Mie-scattering fluorescence filter unit 750 filters the scattering light passing through the Mie-scattering fluorescence inlet 741. In the embodiment, the Mie-scattering fluorescence filter unit 750 is the second band-pass filter unit 750, and mainly, as illustrated in FIG. 6B, the optical density of the second band-pass filter unit 750 has a value greater than 6 and smaller than 9 in order to block the light other than the fluorescence wavelength in a specific band (in the embodiment (320 to 505 nm, average wavelength of about 480 nm)).

As such, through the configuration of the first band-pass filter unit 311d and the second band-pass filter unit 750 described above, the fluorescence light is detected by dividing a wavelength band of the fluorescence light among the incident light to increase a detectable wavelength band of the fluorescence light among the incident light irradiated to the measurement sample, thereby increasing the detection resolution of equipment and securing accurate detection data from the fluorescence light.

The second condensing lens unit 760 serves to converge the parallel fluorescence light that has passed through the Mie-scattering fluorescence filter unit 750 to a Mie-scattering fluorescence sensor unit 780 to be described below.

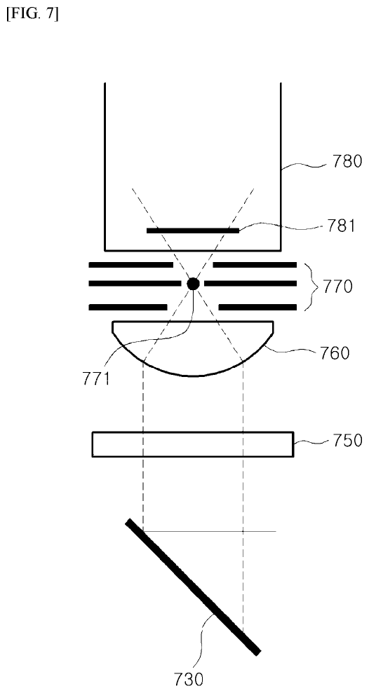

Referring to FIG. 7, the Mie-scattering light control unit 770 may include a plurality of light control units, and only three light control units are illustrated in FIG. 7 for convenience of explanation, but according to a design, the number of 3 or more or 3 or less may be applied.

An aperture is formed in the center of each of the plurality of light control units 770 to transmit incident light transmitted from the Mie-scattering condensing lens unit 760 to the Mie-scattering fluorescence sensor unit 780, and the aperture of each of the plurality of light control units 770 is set to be smaller as being close to a focus 771. That is, the plurality of light control units have relatively large apertures as being far away from the left and right based on the focus 771.

Accordingly, the Mie-scattering light control unit 770 may block an entering signal diffusely reflected by passing through the Mie-scattering fluorescence filter unit 750 into the Mie-scattering fluorescence sensor unit 780, thereby improving the fluorescence detection ability, that is, the ability to detect microorganisms.

The Mie-scattering fluorescence sensor unit 780 detects the presence or absence of microorganisms and the amount thereof from the transmitted light. That is, the Mie-scattering fluorescence sensor unit 780 receives the fluorescence light emitted to the outside of the second light exit port 180 and generates a detection signal for the received light to transmit the detection signal to a signal processing unit (not illustrated).

Like the first fluorescence detecting unit 320 described above, a fluorescence sensor 781 of the second fluorescence detecting unit 740 may be implemented as a photo multiplier tube (PMT), and the detected fluorescence light may include information on the presence or absence of microorganisms and the amount thereof.

The signal detected by the Mie-scattering fluorescence sensor unit 780 is transmitted to the signal processing unit to calculate the presence or absence and the amount of microorganisms according to a predetermined algorithm.

As such, it is possible to detect fluorescence light in a specific wavelength band (495 to 605 nm) emitted to the first light exit port 170 through the sample chamber 110 and fluorescence light in a specific wavelength band (320 to 505 nm) through the first light-receiving unit 300 for detecting all scattering light of the light-transmitting unit and a second light-receiving unit in a Mie-scattering manner simultaneously or sequentially.

Therefore, the specific wavelength bands are detected in two manners to increase a detectable wavelength band of fluorescence light among incident light irradiated to the measurement sample, thereby improving the detection resolution of the equipment and secure accurate detection data from the fluorescence light.

Further, the detection is enabled in a double detecting manner through the second light-receiving unit 700 of Mie-scattering together with the first light-receiving unit 300 of the sample chamber 110 to improve the detection performance due to optical noise as compared with the related art and minimize the diffused reflection by the lens, thereby improving the detection efficiency.

As described above, although the present invention has been described in detail using preferred embodiments, the scope of the present invention is not limited to specific embodiments and should be construed according to the appended claims. In addition, those skilled in the art will understand that many modifications and variations are possible without departing from the scope of the present invention.

### INDUSTRIAL APPLICABILITY

The present invention relates to an apparatus for detecting fine dust and microorganisms capable of improving the detection efficiency by enabling detection in a double detection manner through a second light-receiving unit of Mie-scattering together with a first light-receiving unit of a sample chamber to improve the detection performance due to optical noise as compared with the related art and minimizing the diffused reflection by the lens, and has industrial applicability.

1. An apparatus for detecting fine dust and microorganisms comprising:
a sample chamber body comprising a sample chamber into which a measurement sample is introduced and of which the inside is implemented as a reflector, a light-incidence port through which incident light is incident, and a first light exit port and a second light exit port for emitting the incident light irradiated to the measurement sample;
a light-transmitting unit which irradiates the incident light from the light-incidence port and blocks ambient light from entering the incident light;
a first light-receiving unit which separately transmits, via a first path and a second path, exiting light emitted from the first light exit port, detects scattering light from the exiting light transmitted via the first path, and detects fluorescence light of the exiting light transmitted via the second path so as to detect fluorescence light of a predetermined wavelength band from wavelength bands irradiated from the light-transmitting unit;
a diffused reflection reduction unit provided between the first light exit port and the first light-receiving unit to reduce diffused reflection light emitted from the first light exit port; and
a second light-receiving unit which condenses in a Mie-scattering manner and transmits exiting light emitted from the second light exit port and detects fluorescence light of the exiting light emitted from the second light exit port so as to detect fluorescence light of the remaining wavelength bands not received by the first light-receiving unit from the wavelength bands irradiated from the light-transmitting unit.

2. The apparatus for detecting fine dust and microorganisms of claim 1, wherein the reflector includes an upper body and a lower body,
the upper body is a circular mirror, and the lower body is an elliptical mirror, and
the circular mirror is formed with an aperture corresponding to the first light exit port.

3. The apparatus for detecting fine dust and microorganisms of claim 2, wherein the center of the circular mirror is a first focus of the elliptical mirror, and
the diffused reflection reduction unit is coupled to the position of a second focus of the elliptical mirror.

4. The apparatus for detecting fine dust and microorganisms of claim 1, wherein the diffused reflection reduction unit is provided in a disk shape.

5. The apparatus for detecting fine dust and microorganisms of claim 4, wherein a lower inner diameter and an upper inner diameter of a through hole formed in the aperture of the disk are formed to have different diameters from each other.

6. The apparatus for detecting fine dust and microorganisms of claim 4, wherein the first light-receiving unit comprises
a first condensing lens unit for condensing exiting light emitted from the first light exit port;
a first spectral element which reflects exiting light with the same wavelength as the incident light of the exiting light condensed by the first condensing lens unit via the first path and passes through the exiting light with a different wavelength via the second path; and
a first fluorescence detecting unit for detecting the fluorescence light from the exiting light via the second path.

7. The apparatus for detecting fine dust and microorganisms of claim 6, wherein the lower wall of the disk is provided with a first band-pass filter unit having an optical density of 9 or more.

8. The apparatus for detecting fine dust and microorganisms of claim 1, wherein the second light-receiving unit comprises
a second condensing lens unit for condensing exiting light emitted from the second light exit port;
a second spectral element which reflects exiting light with the same wavelength as the incident light of the exiting light condensed by the second condensing lens unit via the third path and passes through the exiting light with a different wavelength from the incident light of the exiting light condensed by the first condensing lens unit via the fourth path;
a third spectral element which reflects fluorescence light having a different wavelength from the incident light of the exiting light passing through the second spectral element via the fifth path and transmits light having a wavelength other than the fluorescence light of the exiting light reflected by the second spectral element via the sixth path; and
a second fluorescence detecting unit for detecting the fluorescence light from the exiting light via the fifth path.

9. The apparatus for detecting fine dust and microorganisms of claim 8, wherein the second fluorescence detecting unit comprises
a Mie-scattering fluorescence filter unit which is implemented as a second band-pass filter unit having an optical density of greater than 6 and smaller than 9 to block the light other than the fluorescence wavelength and transmit only the exiting light having the fluorescence wavelength;
a Mie-scattering condensing lens unit for condensing the exiting light passing through the Mie-scattering fluorescence filter unit; and
a Mie-scattering light control unit for removing optical noise included in the exiting light condensed by the Mie-scattering condensing lens unit.

10. The apparatus for detecting fine dust and microorganisms of claim 1, wherein the light-transmitting unit irradiates incident light of a wavelength band of 320 nm to 605 nm,
a predetermined wavelength band of the fluorescence light of the first light-receiving unit is 495 nm to 605 nm, and
the remaining wavelength bands of the fluorescence light of the second light-receiving unit are 320 nm to 505 nm.
